(19) United States
(12) Patent Application Publication
(10) Pub. No.: US 2013/0212954 A1
(43) Pub. Date: Aug. 22, 2013

(54) ROOF HATCH FOR USE IN HURRICANE REGIONS

(71) Applicant: NYSTROM, INC., (US)

(72) Inventors: Ian M. Taylor, Eagan, MN (US); Steven G. Stepp, North Branch, MN (US); John R. Chiodo, Columbia Heights, MN (US)

(73) Assignee: NYSTROM, INC., Brooklyn Park, MN (US)

(21) Appl. No.: 13/773,002

(22) Filed: Feb. 21, 2013

Related U.S. Application Data
(60) Provisional application No. 61/601,341, filed on Feb. 21, 2012.

(51) Int. Cl. E06B 5/10

(52) U.S. Cl. CPC E06B 5/10
USPC 52/19; 52/741.1

(57) ABSTRACT

A roof hatch including a vibration resistant latch design that can accommodate stresses applied to the roof hatch during hurricane conditions. The roof hatch can comprise a latch assembly including a biasing portion, a linkage member and a latch portion. The biasing portion can include a first latch incorporating a spring returned handle. The latch portion can include a single point, rotatable slam latch that engages an engagable locking member adapted to prevent spring driven rotary arms from disengaging from the engagable locking member. The linkage member includes a projecting end that is designed to provide a delay between actuation of the biasing portion and engagement of the latch portion. Using the vibration resistant latch design, engagable locking member and the rotatable slam latch, the roof hatch is rated to withstand internal and external pressure of 100 pounds per square foot with a design safety factor up to 200 pounds per square foot.

### RELATED APPLICATION

The present application claims the benefit of U.S. Provisional Application No. 61/601,341 entitled ROOF HATCH FOR USE IN HURRICANE REGIONS and filed Feb. 21, 2012, which is incorporated herein in its entirety by reference.

### FIELD OF THE INVENTION

The present invention relates to roof and safety hatches used in the construction industry. More specifically, the present invention relates to a roof hatch that has been designed to withstand environmental forces common to geographical regions that experience hurricanes and tropical storms.

### BACKGROUND OF THE INVENTION

Commercial and industrial buildings frequently have roof mounted environmental, power, or other utility systems. Roof hatches are typically installed to provide maintenance personnel or contractors with roof access for maintaining the existing equipment or installing new equipment. Conventional roof hatches typically comprise a curb set into the roof top and defining an opening through the roof top. The roof hatches also comprise a hatch door rotatable between a closed position in which the hatch door covers the opening and a vertical or angled open position in which the opening is unobstructed for passage through the opening. A latch assembly is typically used to secure the hatch door to the curb to maintain the hatch door in the closed position until the latch assembly is disengaged.

A typical design consideration for roof hatch latch assemblies is that the latch assembly can secure the hatch door in the closed position. In particular, as roof hatches are typically exterior doors, the latch assembly must typically retain the hatch door in the closed position against strong winds and rain from inclement weather. While conventional latch assemblies are typically adequate to prevent hatch doors from being forced open during inclement weather, the extreme winds in hurricanes and typhoons can force latch assemblies open. The high speed winds can induce a vibration in the hatch door causing the latch assemblies to disengage. In addition, the high speed winds can create a vacuum pulling on the hatch door straining the mechanisms of the latch assembly. An added consideration is that the strong winds of the hurricane can pick up and hurl debris. The debris can also impact the actuation handles of the latch assembly damaging the latch assembly or causing handles to move and disengage the latch assembly.

The significant strain placed on roof hatches in hurricane and typhoon regions creates a need for roof hatches having latches capable of withstanding the strain placed on the hatches from the high winds and associated vacuum while being capable of surviving impacts from debris.

### SUMMARY OF THE INVENTION

The present invention is directed to a roof hatch having a latch assembly for releasably securing the hatch door to the curb in the closed position. Specifically, the latch assembly comprises a partially “free-floating” handle that reduces the likelihood that the latch assembly will inadvertently disengage due to vibration, impacts from debris and other stresses placed on the roof hatch during hurricane or other inclement weather conditions that can induce the hatch door to open. The latch assembly can generally comprise a pair of spring driven rotary arms operably affixed to the hatch door and biased to grip a engagable locking member affixed to the curb to prevent the hatch door from being opened. The latch assembly can also comprise a latch arm having a projecting end rotatable by a handle into engagement with the rotary arms to open the rotary arms and release the engagable locking member allowing the hatch door to be opened. The projecting end of the latch arm is shortened to allow the handle to be rotated a predetermined rotational distance before the projecting end engages the rotary arm to open the rotary arms. The free-floating handle prevents minor rotation of the handle from vibration or debris impacts from partially or completely disengaging the rotary arms. Unlike conventional latches where the “slop” in the handle is undesirable, the free-floating portion of the handle rotation counteracts the extreme stresses can be applied to the roof hatch during hurricanes and other inclement weather.

A roof hatch, according to an embodiment of the present invention, comprises a hatch door, a curb and a latch assembly. The curb can define an opening and further comprise an engagable locking member. The hatch door can be affixed to the curb in a hinged configuration such that the hatch door is rotatable between a closed position in which the hatch door covers the opening defined by the curb and an open position in which the hatch door is rotated away from the curb to expose the opening. The latch assembly can further comprise a latch portion, a biasing portion and a linkage member. The latch portion further comprises a pair of spring driven rotary arms rotatable between an open position in which a pair of corresponding ends of the rotary arms are separated and a closed position in which the corresponding ends of the rotary arms are engaged. In one aspect, the latch portion further comprises at least one latch arm linked to the rotary arms such that the rotation of the latch arm moves the rotary arms between the opened and closed positions. The biasing portion further comprises a rotatable handle positioned on the exterior side of the hatch door and having a shaft extending through the hatch door. The linkage member can further comprise a linkage arm comprising a projecting end extending at an angle transverse to the linkage arm. The handle is operably engaged to the linkage arm such that rotation of the handle rotates the projecting end into engagement with the latch arm to rotate the latch arm and open the rotary arms.

In operation, when the rotary arms are positioned in the closed position, the projecting end is positioned proximate to, but out of engagement with the latch arm. The handle can then be rotated to close the space between projecting end and the linkage arm, wherein further rotation of the handle operates the latch arm to open the rotary arms and release the engagable locking member. The initial spacing between the latch arm and projecting end allows the handle to rotate a predetermined distance before the projecting end engages the latch arm and begins to open the rotary arms. As a result, vibrations in the latch assembly or debris impacting the handle can move the handle a predetermined distance without disengaging the rotary arms. In addition, this arrangement precludes the need for stronger latch springs that can make intentional operation of the latch assembly more difficult.

A latch assembly, according to an embodiment of the present invention, for use with a roof hatch having a hatch door and curb comprising a engagable locking member, can comprise a latch portion, a rotatable handle and a linkage arm. The latch portion further comprises a latch arm and a pair of spring driven rotary arms, wherein rotating the latch arm rotates the rotary arms between an open position in which a pair of corresponding ends of the rotary arms are separated and a closed position in which the corresponding ends of the rotary arms are engaged. The rotatable handle is operably engaged to the linkage arm to rotate the linkage arm into engagement with the latch arm for rotation of the latch arm, wherein the linkage arm further comprises a radially extending projecting end sized to create a predetermined distance between the latch arm and the linkage arm increasing the distance that rotatable handle has to be rotated before the linkage arm engages the latch arm.

A method of securing a hatch door to a curb, according to an embodiment of the present invention, comprises fastening an engagable locking member to the curb. The method can further comprise fastening a latch portion to the hatch door, wherein the latch portion comprises a pair of spring driven rotary arms rotatable between an open position in which a pair of corresponding ends of the rotary arms are separated and a closed position in which the corresponding ends of the rotary arms are engaged to grip the engagable locking member. The method can also comprises providing a handle operably engaged to a linkage arm, wherein rotation of the handle moves the linkage arm into engagement with the latch portion to move the rotary arms into the open position. The method can comprise rotating the handle through a first rotational distance, wherein latch arm engages the latch portion at the end of the first rotational distance. Finally, the method can also comprise continued rotation of the handle through a second rotational distance, wherein the latch arm is engaged to the latch portion such that rotation of the handle through the second rotational distance operates the latch portion to open the rotary arms.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The invention can be completely understood in consideration of the following detailed description of various embodiments of the invention in connection with the accompanying drawings, in which:

FIG. 1 is a top perspective view of hurricane rated roof hatch according to an embodiment of the present invention.

FIG. 2 is a bottom view of a door for use with the hurricane rated roof hatch of FIG. 1.

FIG. 3 is a top perspective view of the hurricane rated roof hatch of FIG. 1 with a door in a closed position.

FIG. 4 is an exploded perspective view of a vibration resistant latch assembly according to an embodiment of the present invention.

FIG. 5 is a section view of the hurricane rated roof hatch of FIG. 1 including the vibration resistant latch assembly of FIG. 4.

FIG. 6 is a perspective view of a linkage member according to an embodiment of the present invention.

FIG. 7 is a perspective view of the linkage member of FIG. 6.

FIG. 8 is a side view of the linkage member of FIG. 6.

FIG. 9 is a top view of the linkage member of FIG. 6.

FIG. 10 is an end view of the linkage member of FIG. 6.

FIG. 11 is a perspective view of a latch assembly according to an embodiment of the present invention.

FIG. 12 is a top perspective view of a portion of the vibration resistant latch assembly of FIG. 4.

FIG. 13 is a top perspective view of a portion of the vibration resistant latch assembly of FIG. 4.

FIG. 14 is a perspective view of an engagable locking member bracket assembly according to an embodiment of the present invention.

FIG. 15 is a perspective view of the engagable locking member bracket assembly of FIG. 14.

FIG. 16 is a top perspective view of a portion of the vibration resistant latch assembly of FIG. 4.

FIG. 17a is an illustrative top view depicting the rotation of an exterior handle through its rotational range to engage a linkage member with a latch arm.

FIG. 17b is an illustrative top view depicting the rotation of the exterior handle depicted in FIG. 17a, wherein the exterior handle is rotated through its first rotational distance in which the linkage member avoids contact with the latch arm until the handle is rotated through the entire first rotational distance.

FIG. 17c is an illustrative top view depicting the rotation of the exterior handle depicted in FIG. 17a, wherein the exterior handle is rotated through its second rotational distance in which the linkage member contacts and rotates the latch arm to disengage a latch assembly.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

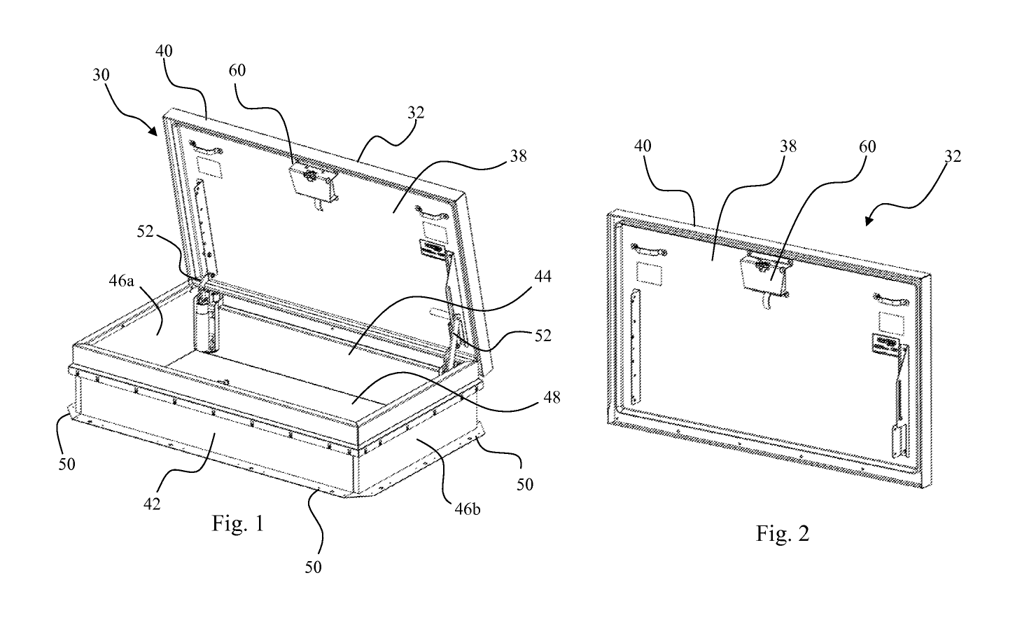

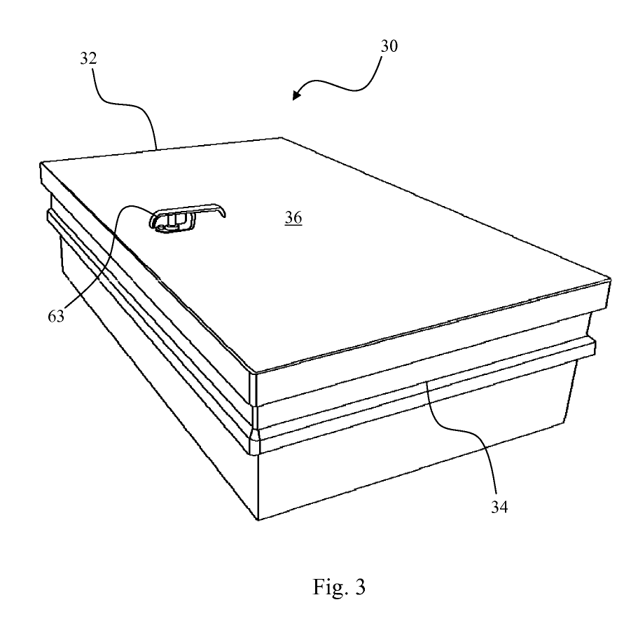

As depicted in FIGS. 1-3, a roof hatch 30, according to an embodiment of the present invention, can comprise a hatch door 32 and a curb 34. The hatch door 32 and curb 34 are each generally fabricated of suitable materials including, but not limited to aluminum, painted carbon steel, stainless steel, high strength composites and combinations thereof. As depicted in FIGS. 1-3, the hatch door 32 generally comprises an outer door surface 36, an inner door surface 38 and a perimeter lip surface 40. In one aspect, the hatch door 32 can comprise a generally rectangular shape approximately thirty inches in depth and fifty four inches wide, though a wide variety of dimensions would be suitable for roof hatch 30. The curb 34 generally comprises a front projecting wall 42, a rear projecting wall 44 and a pair of parallel side projecting walls 46a, 46b. The front projecting wall 42, rear projecting wall 44 and pair of parallel side projecting walls 46a, 46b are arranged in a generally rectangular configuration to define a hatch opening 48. In one aspect, each projecting wall 42, 44, 46a, 46b can define a flanged attachment surface 50 for coupling the curb 34 to a roof surface. The roof hatch 30 can further comprise at least one hinge 52 for rotatably connecting the hatch door 32 to the curb 34. In operation, the roof hatch 30 is rotatable between a closed position in which the hatch door 32 covers the hatch opening 42 as shown in FIG. 3 and an open position in which the roof hatch 30 is angled relative to the curb 34 such that the hatch opening 42 is exposed as shown in FIG. 1.

As depicted in FIGS. 1-2 and 4-5, the roof hatch 30 further comprises a latch assembly 60 for securing the hatch door 32 to the curb 34 when the hatch door 32 in the closed position. The latch assembly 60 comprises a biasing portion 62, a linkage member 64, a latch portion 66 and an engagable locking member bracket assembly 69. Generally, the biasing portion 62, the linkage member 64 and the latch portion 66 are operably affixed to the hatch door 32 while the engagable locking member bracket assembly 69 is affixed to the curb 34. In operation, the latch portion 66 releasably engages the engagable locking member bracket assembly 69 to secure the hatch door 32 to the curb 34.

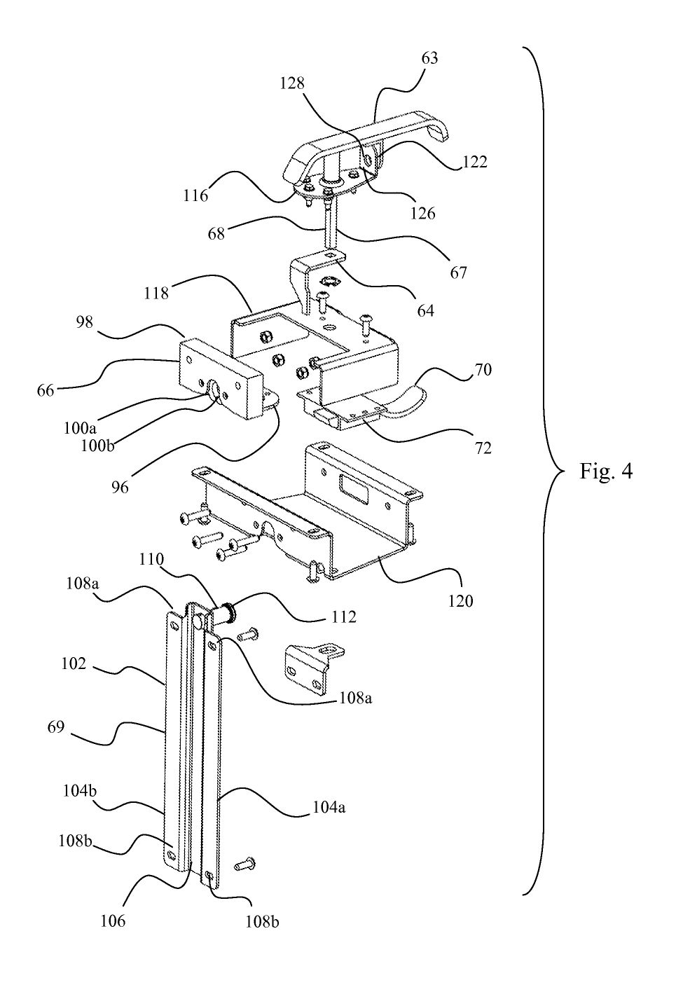

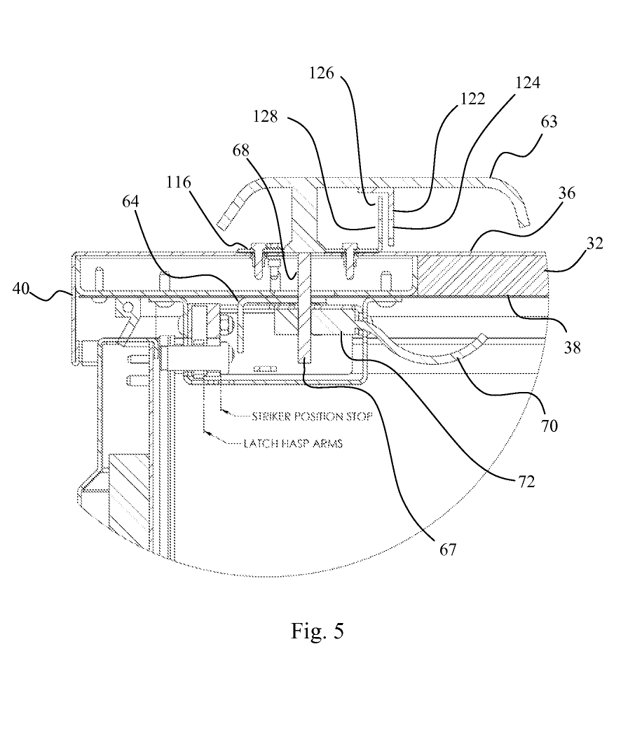

As depicted in FIGS. 4-5, the biasing portion 62 comprises an exterior handle 63 and a non-circular shaft member 67. In one aspect, the exterior handle 63 includes a handle locking bracket 122 having a handle aperture 124 while the exterior locking bracket 116 includes a flanged bracket surface 126 having a bracket aperture 128. In operation, the exterior handle 63 is positioned on the outer door surface 36 side of the hatch door 32. The non-circular shaft member 67 comprises a non-circular cross section 68 and extends from the exterior handle 63 through the hatch door 32 to the interior door surface 38 side of the hatch door 32. The non-circular shaft member 67 can comprise any non-circular cross-section including, but not limited to square or hexagonal cross-section. In one aspect, the biasing portion 62 can further comprise an interior handle 70 operably coupled to the non-circular shaft member 67. The exterior handle 63 and/or the interior handle 70 can be manually rotated to rotate the non-circular shaft member 67 between a first position and a second position, wherein the first position corresponds to the latch assembly 60 engaged to grip the engagable locking member bracket assembly 69 and the second position corresponds to the latch assembly 60 disengaged to release the engagable locking member bracket assembly 69. In one aspect, the biasing portion 62 can further comprise a spring return latch 72 for basing the non-circular shaft member 67 and the exterior and interior handles 64, 70 back to the first position after the non-circular shaft member 67 is rotated toward the second position.

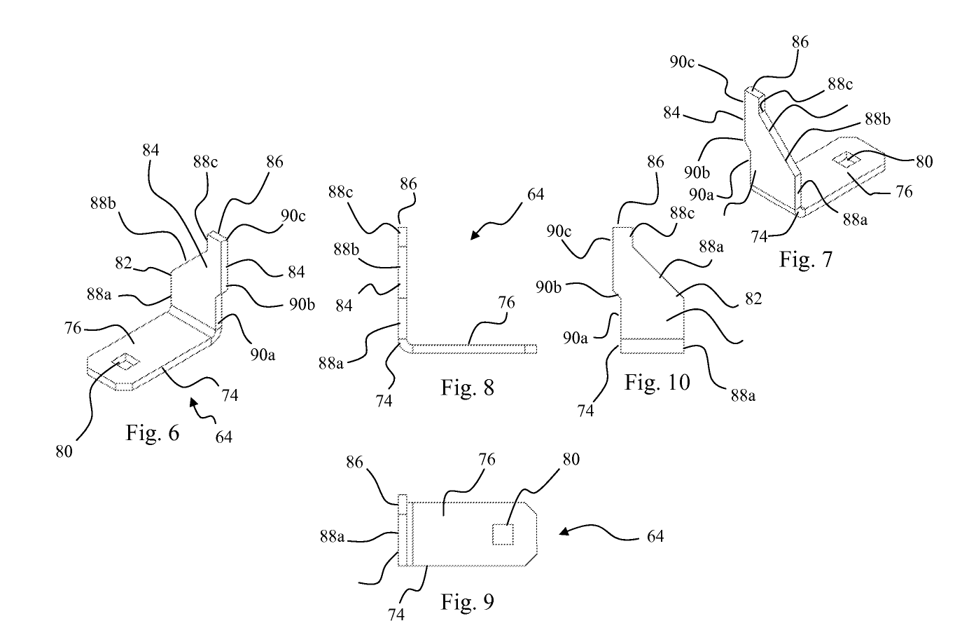

As depicted in FIGS. 6-9, the linkage member 64 comprises an L-shaped body member 74 having a biasing surface 76 and a latch surface 78. The biasing surface 76 further comprises a non-circular biasing aperture 80 sized to tightly receive the non-circular shaft member 67 and shaped to correspond to the non-circular cross-section 68. The latch surface 78 is shaped to include a first side 82, a second side 84 and a projecting end 86. The first side 82 is defined by a first side portion 88a, a first angled portion 88b and a first side portion 88c. The second side 84 is defined by a second side portion 90a, a second angled portion 90b and a second side portion 90c. In this arrangement, the projecting end 86 comprises a projecting width 92 significantly less than a latching width 94 defined proximate to the biasing surface 76.

As depicted in FIGS. 4-5, the latch portion 66 comprises a latch arm 96 and a rotatable slam latch 98. The slam latch 98 further comprises a pair of spring driven rotary arms 100a, 100b.

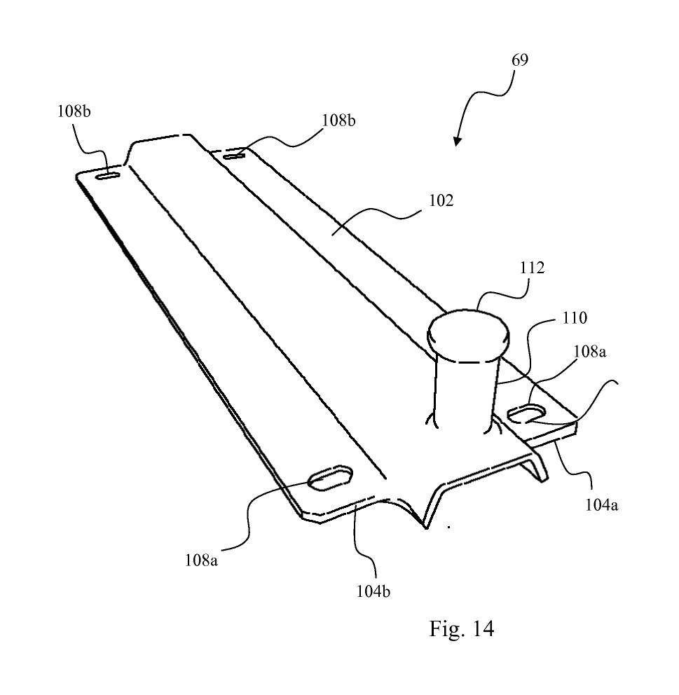

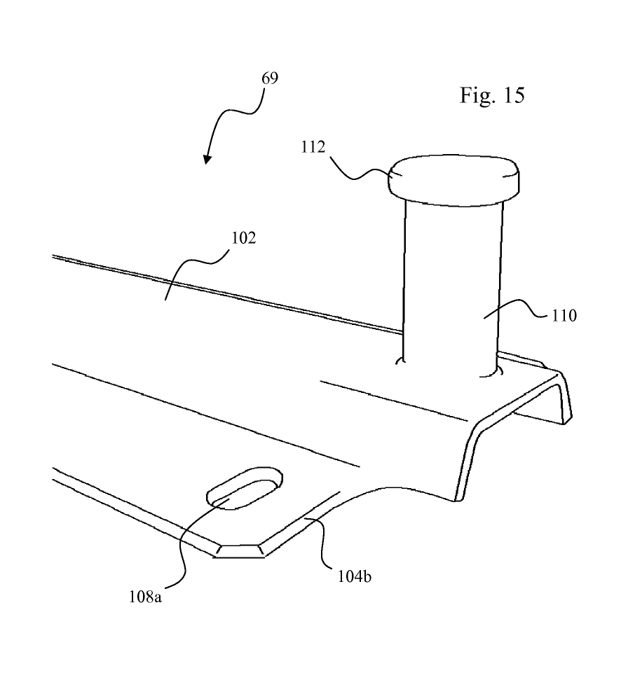

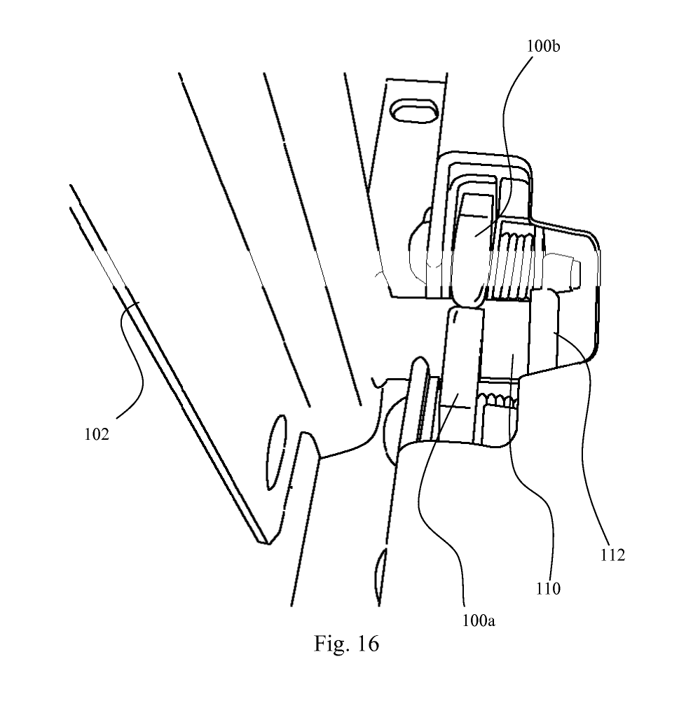

As depicted in FIGS. 4-5 and 14-15, the engagable locking member bracket 69 comprises a body member 102 having a pair of attachment surfaces 104a, 104b and a striker surface 106. Each attachment surface 104a, 104b further comprises a pair of attachment apertures 108a, 108b. The striker surface 106 further comprises an engagable locking member 110 such as a striker bolt having a generally circular cross-section and an enlarged end surface 112 defining a bolt flange 114. In certain embodiments, the engagable locking member 110 can further comprise other conventional latching structures engagable by the latch assembly 60.

During assembly, the engagable locking member bracket 69 is affixed to the front projecting wall 42 by inserting appropriately sized fasteners such as screws or bolts through the attachment apertures 108a, 108b of the attachment surfaces 104a, 104b and into corresponding apertures in the front projecting wall 42 of the curb 34. The apertures on the front projecting wall 42 are positioned such that engagable locking member 110 is positioned proximate to the hatch opening 42. In one aspect, the engagable locking member bracket 69 can comprise an extended length such that the engagable locking member bracket 69 acts as a stiffening member reinforcing the front projecting wall 42 of the curb 34.

The biasing portion 62 is secured to the hatch door 32 such that the exterior handle 63 is positioned on the outer door surface 36. In one aspect, the biasing portion 62 further comprises an exterior locking bracket 116 for securing the biasing portion 62 to the outer door surface 36. In this configuration, the exterior locking bracket 116 is adapted to receive at least one fastener to secure the exterior locking bracket 116 and correspondingly the biasing portion 62 to the outer door surface 36 of the hatch door 32. The exterior handle 63 is positioned on the outer door surface 36 such that the non-circular shaft member 67 extends through the exterior locking bracket 116 and the hatch door 32 via a door aperture (not shown). In one aspect, the biasing portion 62 further comprises a first internal mounting bracket 118 positionable over the non-circular shaft member 67 and adapted to receive at least one fastener to secure the internal mounting bracket 118 to the inner door surface 38. The biasing apertures 80 of the linkage member 64 can be positioned to receive a portion of the non-circular shaft member 67 inserted through the hatch door 32 such that the biasing surface 76 is positioned proximate to the inner door surface 38. The spring return latch 72 is coupled to the non-circular shaft member 67. As depicted in FIG. 5, in one aspect, the biasing portion 62 can further comprise a second internal mounting bracket 120 to which the rotatable slam latch 98 is mounted. As with the first internal mounting bracket 118, the second internal mounting bracket 120 is adapted to receive at least one fastener to secure the second internal mounting bracket 120 to the inner door surface 38. In this configuration, the spring driven rotary arms 100a, 100b are positioned proximate to the front projecting wall 42.

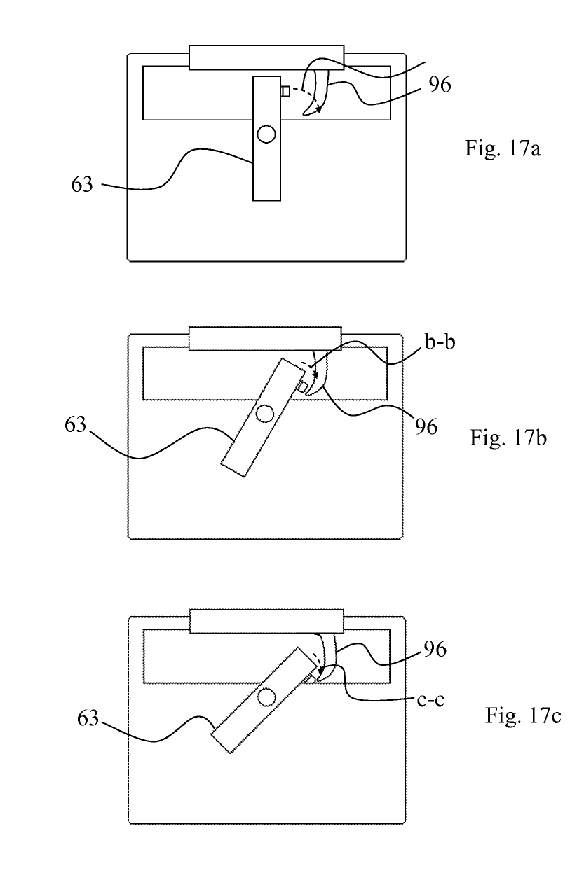

In operation, the exterior handle 63 can be rotated manually to rotate the non-circular shaft member 67 to disengage the latch assembly 60 from the exterior side of the roof hatch 30. In one aspect, the exterior handle 63 is rotated through rotational range a-a defined by a first rotational distance b-b and a second rotational distance c-c as depicted in FIGS. 17a-17c. Correspondingly, the interior handle 70 can also be rotated manually to rotate the non-circular shaft member 67 to disengage the latch assembly 60 from the interior side of the roof hatch 30. The corresponding shape of the non-circular biasing aperture 80 to the non-circular shaft member 67 causes the linkage member 64 to rotate with the non-circular shaft member 67 when the non-circular shaft member 67 is rotated by either the exterior handle 63 or the interior handle 70. In this configuration, the projecting end 86 of the linkage member 64 comprises a reduced width to create a predetermined gap between the edge of the projecting end 86 and the latch arm 96. The gap creates a delay between rotation of the exterior handle 63 and the interior handle 70 during the first rotational distance b-b and the corresponding engagement of the latch arm 96 with the projecting end 86 to trigger the disengagement of the latch assembly 60 during the second rotational distance c-c. The built in delay or “play” allows vibration in the roof hatch 30 or limited movement of the exterior handle 63 due to environmental conditions or flying debris without risk that the latch assembly 60 will partially or fully disengage causing the hatch door 32 to open.

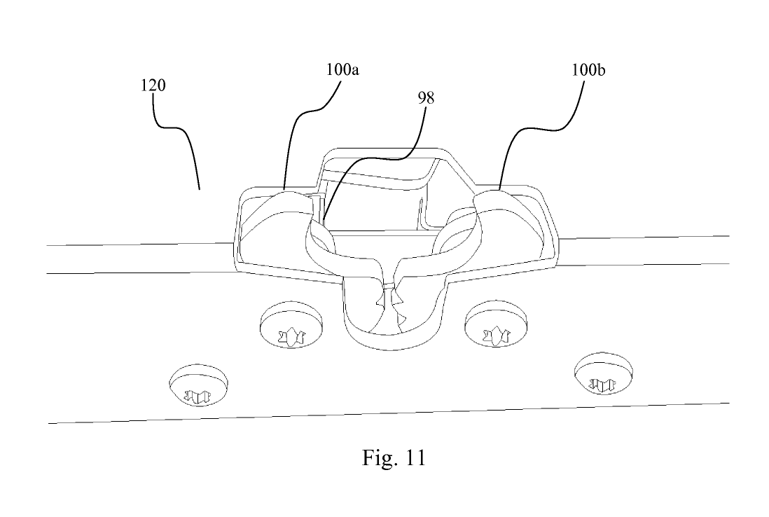

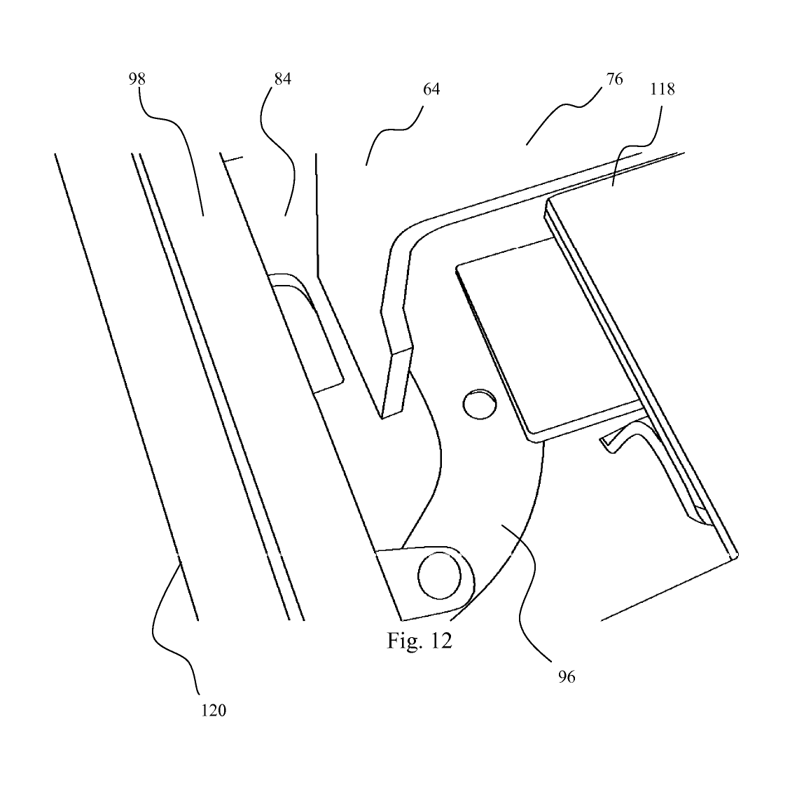

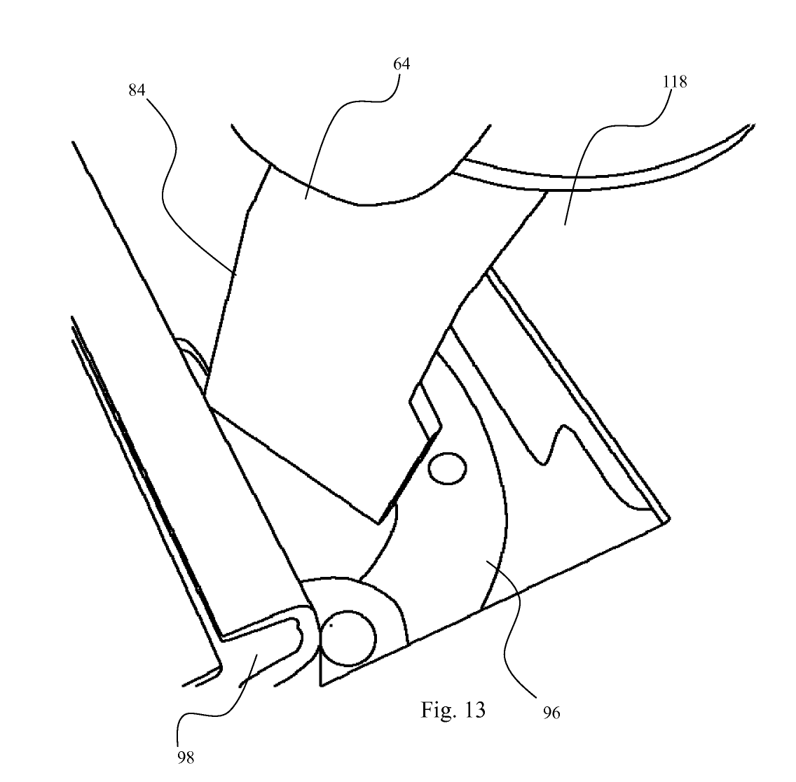

As depicted in FIGS. 5, 11-13 and 15, in operation, the hatch door 32 is rotatable between a closed position in which the hatch door 32 is positioned against the curb 34 covering the hatch opening 48 and an open position in which the hatch door 32 is angled transverse to the curb 34 to expose the hatch opening 48. In one aspect, the hatch door 32 is sized such that the perimeter lip surface 40 extends over the hatch opening 48 to prevent precipitation from entering the hatch opening 48. In another aspect, the perimeter lip surface 40 can extend sufficiently past the edges of the hatch opening 48 to prevent precipitation clinging to the lip surface 40 from following the perimeter lip surface 40 and entering the hatch opening 48. As the hatch door 32 is rotated into the closed position, the spring driven rotary arms 100a, 100b initially expand and collapse around the engagable locking member 110 to grip the engagable locking member 110 to secure the hatch door 32 to curb 34. The enlarged end surface 112 of each rotary arm 100a, 110b engages the striker surface 106 of the engagable locking member 110 to physically prevent the rotary arms 100a, 100b from being pried off the engagable locking member 110 due to vibration; expansion or contraction of the engagable locking member 110; or debris impact in a hurricane or other inclement weather.

In this configuration, spring driven rotary arms 100a, 100b will only release from the engagable locking member 100 under the direction of the vibration resistant latch assembly 60. Specifically, the spring driven rotary arms 100a, 100b only disengage upon actuation of the latch arm 96 by the projecting end 86 of the biasing portion 62 being rotated by manual rotation of the exterior handle 63 or interior handle 70 to close the predetermined gap and operating the latch arm 96.

With the combination of the vibration resistance achieved by the vibration resistant latch assembly 60 and the positive retention of the strike bolt 110 with spring driven rotary arms 100a, 100b, the roof hatch 30 of the present invention is rated to survive internal and external pressures of 100 pounds per square foot with a design safety factor of up to 200 pounds per square foot. As such, roof hatch 100 satisfies the hurricane design requirements of the Miami-Dade County Product Authority and Florida Building Code (FFBC) using only a single point latch, i.e. the rotatable slam latch 98.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents, as well as the following illustrative embodiments.

1. A vibration and impact resistant roof hatch, comprising:
a curb defining a hatch opening, the curb including an engagable locking member;
a hatch door rotatably attached to the curb such that the hatch door is rotatable relative to the search between a closed position and an open position, the hatch door including a rotatable handle having a rotational range defined by a first rotational distance and a second rotational distance;
a linkage member coupled to the rotatable handle, wherein rotation of the rotatable handle through the rotational range causes the linkage member to rotate relative to the latch assembly; and
a latch assembly attached to the hatch door, the latch assembly being configured to engage the latch engagement member when the hatch door is in the closed position, and
wherein the linkage member avoids engagement with the latch assembly as the rotatable handle traverses the first rotational distance and engages the latch assembly as the rotatable handle traverses the second rotational distance.

2. The vibration and impact resistant roof hatch of claim 1, wherein the engagable locking member comprises a striker bolt.

3. The vibration and impact resistant roof hatch of claim 1, wherein the latch assembly further comprises a pair of spring driven rotary arms and a latch arm rotatable to move the rotary arms between an open configuration in which the rotary arms are positioned to avoid engagement with the engagable locking member and a closed configuration in which the rotary arms are positioned to engage the engagable locking member, wherein the linkage member engages and rotates the latch arm as the linkage member as the rotatable handle traverse the second rotational distance.

4. The vibration and impact resistant roof hatch of claim 3, wherein the spring driven rotary arms are biased to the closed configuration.

5. The roof hatch of claim 1, wherein the hatch door further comprises an exterior side and an interior side, wherein the interior side is positioned against the curb when the hatch door is rotated into the closed position.

6. The roof hatch of claim 5, wherein the hatch door comprises a perimeter lip surface extending beyond the hatch opening to define an overhanging portion.

7. The roof hatch of claim 5, wherein the handle is positioned on the exterior side of the hatch door and further comprises a non-circular shaft member extending through the door, wherein the non-circular shaft member is affixed to the linkage member such that the rotation of the handle rotates the linkage member.

8. The roof hatch of claim 7, further comprising an interior handle positioned on the interior side of the hatch door and affixed to the non-circular shaft member such that rotation of the interior handle rotates the linkage member and the exterior handle.

9. The roof hatch of claim 5, wherein the handle is positioned on the interior side of the hatch door.

10. The roof hatch of claim 1, wherein the handle further comprises handle locking bracket defining a handle aperture, wherein the hatch door further comprises a flanged bracket surface defining a bracket aperture, wherein the positioning the handle such that the protruding end is the predetermined distance from the latch arm aligns the handle aperture with the bracket aperture for receiving a fastener to prevent rotation of the handle.

11. The roof hatch of claim 1, wherein the predetermined distance between the protruding end and the latch arm allows limited free rotation of the handle without disengagement of the rotary arms.

12. A method of securing a hatch door to a curb defining a hatch opening, wherein the hatch door comprises an exterior side and an interior side and is rotatable relative to the curb between a closed position in which the interior side of the hatch door is positioned against the curb to cover the opening and an open position in which the hatch door is angled relative to the curb to expose the opening, comprising:
fastening an engagable locking member to the curb;
fastening a latch assembly, a linkage member and a rotatable handle to the hatch door, the latch assembly being configured to engage the latch engagement member when the hatch door is in the closed position, wherein the rotatable handle has a rotational range defined by a first rotational distance and a second rotational distance, wherein the linkage member is affixed to the rotatable handle such that the rotation of the rotatable handle through the rotational range causes the linkage member to rotate relative to the latch assembly;
rotating the hatch door into the closed position, wherein the engagable locking member is positioned on the curb such that the engagable locking member is positioned to be engaged by the latch assembly as the hatch door is rotated into the closed position;
rotating the rotatable handle through the first rotational distance, wherein the linkage member avoids engagement with the latch assembly as the rotatable handle traverses the first rotational distance; and
rotating the rotatable handle through the second rotational distance, wherein the linkage member engages the latch assembly as the rotatable handle traverses the second rotational distance to operate the latch assembly to disengage the engagable locking member.

13. The method of securing a hatch door in claim 12, further comprising:
rotating the handle a first distance to move the linkage arm across the predetermined distance to engage the latch arm, wherein the spring driven rotary arms remain engaged through the rotation of the handle through the first distance; and
rotating the handle a second distance to rotate the linkage arm to rotate the latch arm and open the spring driven rotary arms.

14. The method of securing a hatch door in claim 12, further comprising:
positioning the handle on the exterior side of the hatch door, wherein the handle further comprises a non-circular shaft member extending through the door, wherein the non-circular shaft is affixed to the linkage member such that the rotation of the handle on the exterior side of the hatch door rotates the linkage member.

15. The method of securing a hatch door in claim 14, wherein the roof hatch further comprises an interior handle affixed to the non-circular shaft on the interior side of the hatch door.

16. The method of securing a hatch door in claim 12, wherein the handle further comprises handle locking bracket defining a handle aperture, wherein the hatch door further comprises a flanged bracket surface defining a bracket aperture.

17. The method of securing a hatch door in claim 16, further comprising:
positioning the handle such that the linkage arm is the predetermined distance from the latch arm, wherein the handle aperture and the bracket aperture are aligned in this position; and
inserting a fastener through the bracket aperture and the handle aperture to prevent rotation of the handle.

18. The vibration and impact resistant roof hatch of claim 12, wherein the engagable locking member comprises a striker bolt.

19. The vibration and impact resistant roof hatch of claim 12, wherein the latch assembly further comprises a pair of spring driven rotary arms and a latch arm rotatable to move the rotary arms between an open configuration in which the rotary arms are positioned to avoid engagement with the engagable locking member and a closed configuration in which the rotary arms are positioned to engage the engagable locking member, wherein the linkage member engages and rotates the latch arm as the linkage member as the rotatable handle traverse the second rotational distance.

20. The vibration and impact resistant roof hatch of claim 19, wherein the spring driven rotary arms are biased to the closed configuration.
